(19) United States
(12) Patent Application Publication
(10) Pub. No.: US 2003/0128819 A1
(43) Pub. Date: Jul. 10, 2003

(54) Method for retrieving multimedia messages from a multimedia mailbox

(76) Inventors: Anne Yin-Fee Lee, Naperville, IL (US); Ronald Bruce Martin, Carol Stream, IL (US)

Correspondence Address: Docket Administrator (Room 3J-219), Lucent Technologies Inc., 101 Crawfords Corner Road, Holmdel, NJ, 07733-3030, US

(21) Appl. No.: 10/041,735

(22) Filed: Jan. 10, 2002

(51) Int. Cl. H04M 11/00

(52) U.S. Cl. 379/88.13

(57) ABSTRACT

The present invention provides a method for retrieving multimedia messages from a multimedia mailbox. A communication system receives a request to retrieve a multimedia message from a multimedia mailbox from a calling phone. If the calling phone is capable of processing IP data, the communication system sends a text-based menu interface to the calling phone. The communication system receives a selection of one of the stored messages from the calling phone and initiates a second connection between the multimedia mail system and the calling phone. The communication system sends the selected stored message from the multimedia mailbox to the calling phone over the second connection. The calling phone can send a callback indicator to the multimedia mail system, and the multimedia mail system will establish a call between the calling phone and the depositor of the multimedia message.

### FIELD OF THE INVENTION

The present invention relates generally to communication systems, and more particularly to a method for retrieving multimedia messages in a communication system.

### BACKGROUND OF THE INVENTION

Voice mail systems allow callers to leave a voice mail message for a user associated with a voice mailbox. Callers may be placed into the voice mailbox if the called party does not answer a call, is busy on a preexisting call, or is not in service.

The called party can retrieve voice mail messages from the voice mailbox associated with the user. In current systems, the user dials the phone number of the voice mail system, enters an extension or other alphanumeric representation of the user's account, and enters a password for the account. The user is then told how many messages are in the voice mailbox. The user can then retrieve and listen to each message in sequence. After listening to the message, the user can decide to erase the message or save it in the mailbox for further processing.

Consequently, a voice mail user has to listen to each message in sequence. This can be a problem if there are numerous messages in the voice mailbox, especially if an important message is stored later in the voice mailbox.

It can also be problematic that a user of voice or multimedia mail cannot get information about messages left in a mailbox prior to listening to each message. For example, the user might like to see a list of the sender name, phone number, a title of the message, the length, or other information pertaining to the message. Without such information, traversing a mailbox can be lengthy and difficult.

A further problem with multimedia mail systems is with the Quality of Service (QoS) for calls. If a user connects to a multimedia mail system using a connection that has a low quality of service, such as a best-effort data connection, any message that was left in the mailbox that requires a higher QoS can be irretrievable or garbled. For example, if a depositor has deposited a video message in the multimedia mailbox of the user, but the user has accessed the mail system using a best-effort data connection, the video message would not be optimally received by the mailbox user. The same situation can arise for voice messages or any message that requires a higher QoS than that used by the user of the mail system when accessing the mail system for the connection.

Still a further problem with current multimedia mail systems is that a user may desire to call a depositor of a message in the mail system. Again, if the QoS of the connection to the mail system is low, this may not be feasible due to a lack of required bandwidth to make an effective second connection between the mail system user and a depositor of mail in the user's mailbox.

Therefore, a need exists for a method and communication system that allows a user to retrieve messages from a mailbox in any order. Further, a need exists for a multimedia mail user to be able to obtain information about all messages in the mailbox without having to listen to each message. Still further, a need exists for a method and communication system to allow a multimedia mail system user to retrieve mail message and make a connection with a depositor of a mail message, without requiring the user to connect to the mail system using a high QoS connection.

### BRIEF SUMMARY OF THE INVENTION

The present invention provides a method for retrieving multimedia messages from a multimedia mailbox. A communication system receives a request from a calling phone. The request is to retrieve a multimedia message from a multimedia mailbox associated with a user of the IP capable phone. The communication system determines if the calling phone is capable of processing IP data. If the calling phone is capable of processing IP data, the communication system sends a text-based menu interface to the calling phone. The list of messages can be for various types of messages, such as voice messages, HTML (HyperText Markup Language) tags, and video messages.

In one embodiment of the present invention, the user of the calling phone can make a selection of one of the choices on the menu interface received from the communication system. The communication system receives the selection of one of the stored messages from the calling phone. The communication system initiates a second connection between the multimedia mail system in response to the selection of one of the plurality of stored messages. The second connection can have a different Quality of Service (QoS) than the first connection.

The communication system sends the selected stored message from the multimedia mailbox to the calling phone over the second connection. If the calling phone determines that it desires a connection be established between the calling phone and the depositor of the message in the multimedia mailbox, the calling phone sends a callback indicator to the multimedia mail system. The multimedia mail system then establishes a call between the calling phone and the depositor of the multimedia message. The call between the calling phone and the depositor may have a QoS indicator that exceeds a predetermined service level to ensure that the call has an adequate level of service to successfully complete the call.

### BRIEF DESCRIPTION OF THE SEVERAL VIEWS OF THE DRAWINGS

FIG. 1 depicts a communication system in accordance with the present invention.

FIG. 2 depicts a flow chart of a method for retrieving multimedia messages from a multimedia mailbox in accordance with the present invention.

### DETAILED DESCRIPTION OF THE INVENTION

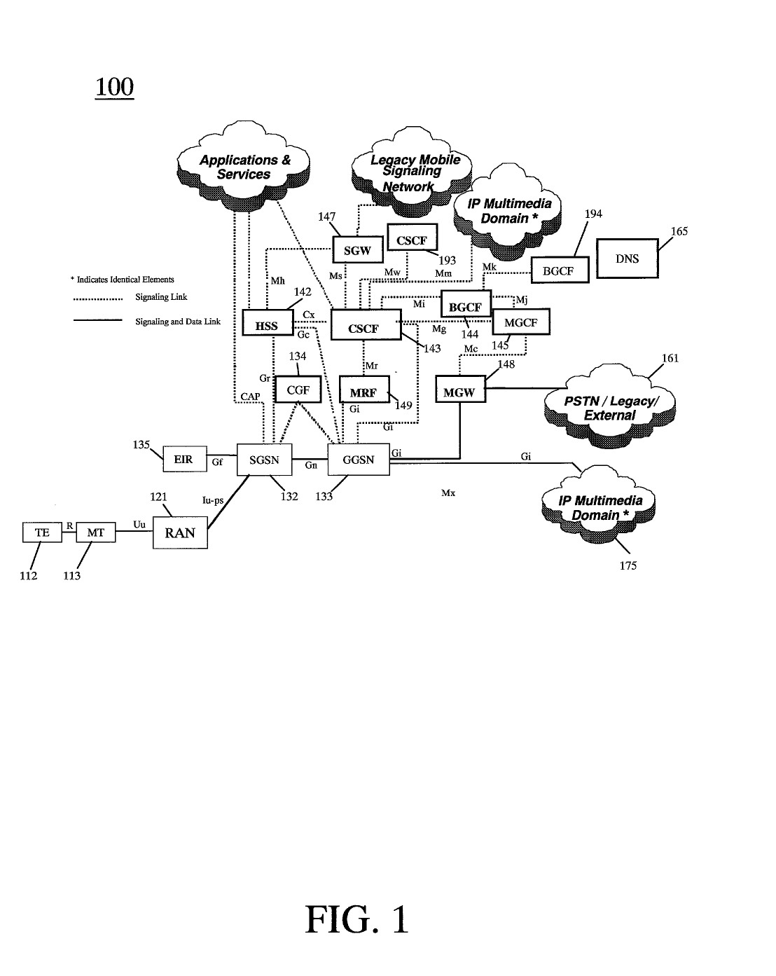

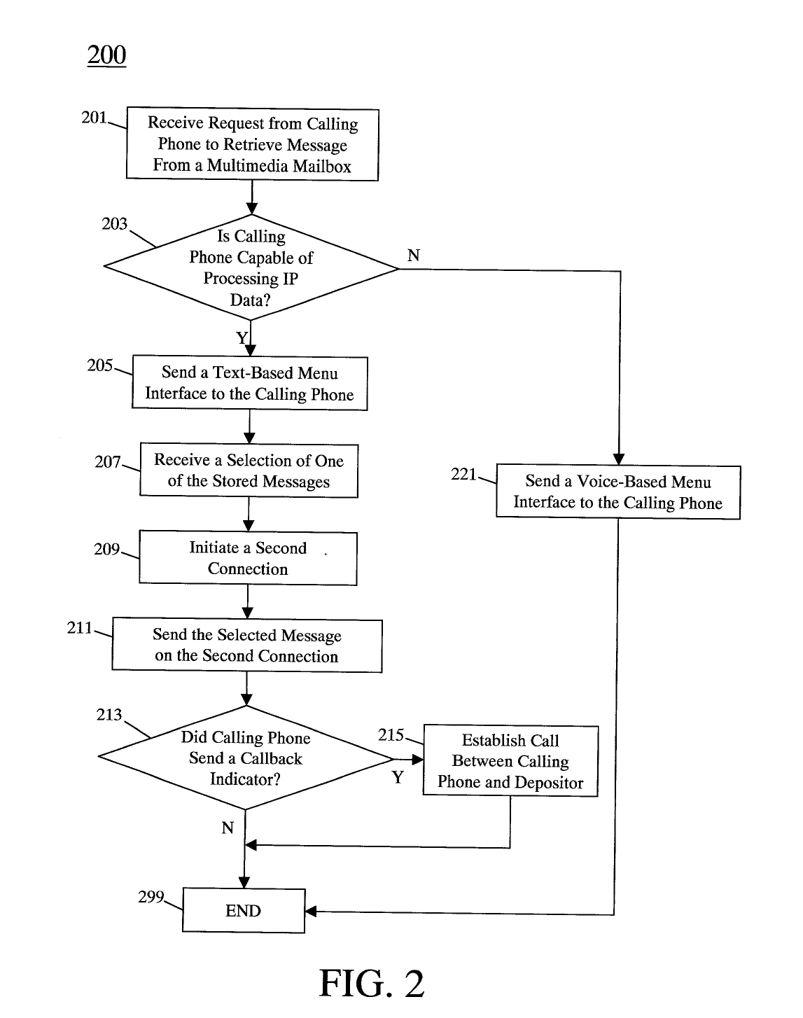

The present invention can be better understood with reference to FIGS. 1 and 2. FIG. 1 depicts a communication system 100 in accordance with the present invention. In an exemplary embodiment depicted in FIG. 1, communication system 100 is a Third Generation (3G) wireless system. Communication system 100 can alternately be any digital cellular system. 3G wireless systems include multiple air interface standards, including cdma2000, Universal Mobile Telecommunications System (UMTS), Wideband CDMA (W-CDMA), Global System for Mobile Communications (GSM), and UWC-136, a TDMA-based technology. As depicted in FIG. 1, communication system 100 depicts a 3GPP reference architecture of a UMTS wireless network. It should be understood that communication system 100 can alternately be other reference architectures. Communication system 100 includes logical elements that have been defined based on network functions that have been grouped together to form each logical element. Actual implementation may contain multiple copies of these logical elements within multiple networks, and can merge any of these logical elements into single hardware entities. The architecture of the present invention is designed to utilize emerging Internet standards and protocols. An example of this is the use of Session Initiation Protocol (SIP) for IP Multimedia Subsystem (IMS) signaling for establishing a call. Use of emerging internet-based protocols, such as IPv6, allows for the IMS to provide internet-like functionality and services to mobile units along with voice and data services.

Communication system 100 includes a plurality of logical elements, comprising Terminal Equipment (TE) 112, a Mobile Termination (MT) 113, Radio Access Network (RAN) 121, packet-switched domain 131, IP Multimedia Subsystem (IMS) 141, Charging Gateway Function (CGF) 134, EIR 135, and signaling gateway (SGW) 147.

Both the UMTS-based and GSM/EDGE-based Radio Access Networks are show in this figure. Charging Gateway Functionality (CGF) 134 is now part of the base 3GPP communication system 100 to show the collection of billing information in packet-switched domain 131. As depicted in FIG. 1, Radio Access Network (RAN) and packet-switched domain 131 are independent of IMS 141.

User equipment can be any device or combination of devices that can be used to connect with a wireless network. User Equipment, for example, can be comprised of Terminal Equipment (TE) 112 and a Mobile Termination (MT) 113. User equipment is preferably a 3G mobile unit that communicates with communication system 100 via an air interface supported by communication system 100.

RAN 121 is preferably a UMTS Terrestrial Radio Access Network (UTRAN), which is the primary interface between the wireless device and the UMTS access network. Alternately, RAN 121 can be a GSM/EDGE Radio Access Network (GERAN), which is the primary interface between the wireless device and the GSM/EDGE access network. RAN 121 is coupled to the user equipment via an air interface, such as a 3G air interface.

Packet-switched domain 131 includes Serving GPRS Support Node (SGSN) 132 and GPRS Gateway Support Node (GGSN) 133. SGSN 132 provides packet mobility management, authentication, session management, accounting, mapping of IP addresses to user equipment identification, such as IMSI, maintenance of mobile state information, and interfacing with GGSN 133. GGSN 133 provides interworking between the SGSNs and external packet data networks using IP.

IMS 141 preferably includes Call State Control Function (CSCF) 143, Breakout Gateway Control Function (BGCF) 144, Media Gateway Control Function (MGCF) 145, Media Gateway (MGW) 148, and Multimedia Resource Function (MRF) 149.

CSCF 143 is a signaling entity for bearer/session control. CSCF 143 manages SIP sessions, provides features/services and coordinates with other network elements for session control, feature/service control and resource allocation.

CSCF 143 performs multiple functions, which in an exemplary embodiment include incoming call gateway, call control function, serving profile database, and address handling. In addition, in accordance with an exemplary embodiment of the present invention, CSCF 143 performs GMSC Emulation as necessary to support call delivery to IMS-homed subscribers being served by a remote MSC server.

CSCF 143 has interfaces with many network elements, preferably as defined by the Third Generation Partnership Project standards, in standards document 3GPP TS 23.002. CSCF 143 is preferably connected to a plurality of elements using the SIP protocol. These network elements include GGSN 133 via interface Gi, MT 113 using interface Gm (not shown), MGCF 145 using interface Mg, BGCF 144 using interface Mi, MRF 149 using interface Mr, IP Multimedia Domain 175 (not shown), and other CSCFs, such as CSCF 193, using interfaces Mw. CSCF 143 is coupled with HSS 142 via interface Cx, preferably using the DIAMETER protocol. CSCF 143 is coupled to SGW 147 via interface Ms, which preferably uses a MAP protocol, but can alternately use a CAP or other SS7 application protocol.

BGCF 144 is a signaling entity for bearer/session control. The primary responsibility of BGCF 144 is to select the network to use for inter-working with PSTN 161 for a call from MT 113 to a PSTN address. BGCF 144 preferably performs additional functions, which include but are not limited to selection of the appropriate MGCF, hiding of network information from other networks, and provision of security through authorization of peer network elements.

BGCF 144 communicates with CSCF 143 via Mi interface, with MGCF 145 via Mj interface, and with BGCF 194 via Mk interface. These interfaces are defined in 3GPP TS 23.002. SIP is the preferred protocol for these standard interfaces. BGCF 144 may also have interfaces with other entities (not shown) to assist in making decisions within communication system 100.

BGCF 144 is preferably a logical entity from the 3GPP reference model. The actual implementation of BGCF 144 may be combined on the same platform with other logical entities that perform signaling functions such as CSCF 143, MGCF 145, and SGW 147.

To select a PSTN gateway, BGCF 144 in the home network receives the call origination message, which is an exemplary embodiment is a SIP INVITE message, from CSCF 143. The receipt of a call origination message from CSCF 143 indicates that the destination is a PSTN address. BGCF 144 needs to determine which network should be used to provide inter-working with PSTN 161. BGCF 144 may use data from multiple sources to make this determination. Examples of factors which BGCF 144 may look at in making this determination include, but are not limited to, the current location of the calling UE, the location of the PSTN address, local policies and business agreements between the visited and home networks, the desire to minimize path distance within the PSTN network, and a desire for the least-cost path. If the PSTN gateway is decided to be the home network, an MGCF within the home network, such as MGCF 145, will be selected. If the PSTN gateway is decided to be at another network, the BGCF address for the other network must be determined so that the processing may be forwarded to that network.

BGCF 144 may also provide information hiding functionality. When two BGCFs are used across a network boundary, then the BGCFs may be used to hide local network information from the other network. BGCF 144 can also provide security in communication system 100. BGCF 144 provides security by performing authorization of peer network elements for peer-to-peer SIP application level communication.

MGCF 145 terminates signaling and provides the call control interface and translations between IMS 141 and PSTN 161. MGCF 145 also provides connection control for the media channels in MGW 148. MGCF 145 communicates with MGW 148 via the Mc interface, with BGCF 144 via the Mj interface, and with CSCF 143 via the Mg interface.

MGCF 145 also preferably provides signaling to control a set of Media Gateways (MGW), such as MGW 148. This signaling is preferably in the form of H.248. With H.248, MGCF 145 is able to control establishment of bearer resources for sessions that require inter-working for bearer between PSTN 161 and IMS 141. For calls that require the services of a network operator's MGW, ports are allocated via requests from MGCF 145 within that network operator's network.

Signaling allows MGCF 145 to perform multiple operations with respect to MGW 148. These operations include MGW registration, bearer establishment control between IMS 141 and PSTN 161, request for allocation of media translation resources (i.e. compression, echo cancellation, vocoding, etc.), control of events detected at MGW 148, application of signals such as tones and announcements by MGW 148, and collection of statistics.

MGCF 145 preferably controls multiple MGWs. To be placed into service, the MGWs register themselves with their default MGCF. After registration with an MGCF, MGWs can begin bearer processing.

MGCF 145 preferably implements a SIP-based interface to CSCF 143. BGCF 144 may be in the signaling path between CSCF 143 and MGCF 145. Using this interface, MGCF 145 accepts commands from CSCF 143 to perform functions related to the control of a call.

MGW 148 is the element that translates between a media flow, such as voice, on a given IP network and bearer data on PSTN 161. MGW 148 terminates circuit-switched bearer traffic from PSTN 161 and terminates IP media flow as packet streams through GGSN 133 or MGW 173, eventually reaching the user equipment. MGW 148 preferably performs vocoding and may also provide tones and announcements. If in-band signaling methods are supported at MGW 148, then for PSTN traffic using in-band signaling, MGW 148 preferably terminates both bearer and signaling traffic, and forwards the signaling messages to MGCF 145. MGW 148 interfaces with GGSN 133 via the Gi interface and with MGCF 145 via the Mc interface.

MGW 148 may include resources to modify a bearer stream. These resources allow MGW 148 to perform encoding, compression, echo cancellation, packetization, transcoding, packet timing synchronization, and packet loss handling.

MGW 148 preferably supports multiple types of voice encoding. These include, but are not limited to, G.711, Adaptive Multi-Rate (AMR), and other G.7xx encoding schemes. MGW 148 is preferably able to use G.711 to encode and decode voice on trunks connected to a PSTN network.

MGW 148 preferably organizes bearer connections using H.248 contexts containing terminations. MGW 148 may include numerous simultaneous contexts.

MGW 148 also preferably includes resources to support a plurality of signaling mechanisms, including but not limited to registration with MGCF 145, detection of events (e.g. Dual-Tone Multi-Frequency (DTMF) detection), application of tones and announcements to bearer streams, graceful teardown and random restart, notification, generation of statistics, and support of H.248 packages.

MRF 149 provides packet-based media services, such as advanced announcement generation and detection, N-way conferencing, tone and announcement generation, and future advanced media services, such as video mixing. MRF 149 also preferably provides transcoding and interactive voice response. MRF 149 interfaces with CSCF 143 via the Mr interface, with IP Multimedia Domain 175 (not shown), and with GGSN 133 via the Gi interface.

In an exemplary embodiment, MRF 149 comprises two parts, a controller part and a bearer part. CSCF 143 preferably interfaces with the MRF controller part to request media services using SIP. The controller part preferably communicates with the bearer part via H.248. The bearer part preferably supports RTP/UDP/IP. Some of the resources maintained by MRF 149 include vocoders, transcoders, compression entities, bearer-stream mixers, echo cancellors, and other DSP resources. Vocoders are needed at MRF 149 for transcoding and mixing of multimedia streams.

HSS 142 provides support for subscriber authentication, subscriber profile management, service authorization, subscriber location management, intersystem handover, and call routing. HSS 142 provides these functions for users receiving service from circuit-switched domain 151, packet-switched domain 131, and IMS 141.

HSS 142 preferably maintains a subscriber database that includes information including, but not limited to, the identity of the subscriber, services and associated policies, location, and authentication data.

HSS 142 supports the following interfaces. Interface Cx is the interface to CSCF 143. The preferred protocol for this interface is DIAMETER. Interface Mh is the interface to SGW 147. Interface Gr is the interface to SGSN 132. Interface Gc is the interface to GGSN 133. Interface C is the interface to GMSC server 153. Interfaces Mh, Gr, Gc, D and C preferably utilize a MAP protocol.

In accordance with an exemplary embodiment of the present invention, HSS 142 recognizes when features and services are to be implemented for a subscriber at either MSC server 152 or IMS 141. In addition, HSS 142 supports procedures for IMS-homed mobile units being served at a remote MSC Server.

SGW 147 terminates transport protocols for signaling between PS domain 113 and IMS 141. The services of SGW 147 are preferably used to ensure transport interworking between the SS7 and the IP transport of signaling on its various interfaces (not all shown). SGW 147 communicates with CSCF 143 and HSS 142 via the Ms and Mh interfaces, respectively.

SGW 147 provides for HSS Subscriber roaming into circuit-switched wireless networks and transport of circuit-switched signaling over IP, such as TCP/IP.

It should be understood that a multimedia mail system can be located within communication system 100. The multimedia mail system is preferably a separate entity, but can alternately be incorporated into various pieces of communication system 100.

FIG. 2 depicts a flow chart 200 of a method for retrieving multimedia messages from a multimedia mailbox in accordance with the present invention. The processes depicted in FIG. 2 can be performed at different entities within communication system 100. The communication system receives (201) a request from a calling phone to retrieve a message from a multimedia mailbox associated with a user of the calling phone. The request preferably utilizes a first connection. In one embodiment of the present invention, the request includes an indicator that the calling phone is capable of processing a text-based menu interface.

In the preferred embodiment of the present invention, the calling phone is capable of sending and receiving data, preferably using the Internet Protocol (IP). The calling phone can be a wireless phone, a wireline phone, a softphone on a computer, a Personal Digital Assistant (PDA), a pen tablet, or a web pad.

The communication system determines (203) if the calling phone is capable of processing IP data. This is preferably accomplished by checking the indicator sent with the request.

If the calling phone is not capable of processing IP data, the communication system sends (221) a voice-based menu interface to the calling phone. For example, the communication system could send a voice message to the calling phone instructing the user of the calling phone to press “1” to hear new messages, press “2” to hear old messages, press “3” to change outgoing messages, and press “4” to change options for the voice mail system. The process then ends (299).

If the calling phone is capable of processing IP data as determined at step 203, the communication system sends (205) a text-based menu interface to the calling phone. The text-based menu interface is preferably sent utilizing IP. In one embodiment, the text-based menu interface is an HTML (HyperText Markup Language) message. In a second embodiment, the text-based menu interface is a Wireless Application Protocol (WAP) message.

The menu interface is preferably a list of messages that are in the mailbox associated with either the calling phone or the user of the calling phone. The list of messages can be for various types of messages, such as voice messages, HTML (HyperText Markup Language) tags, or video messages. The menu interface can include various fields of information pertaining to the messages in the mailbox. This could include, but is not limited to, the sender of the message, the date and time the message was sent, the length of the message, the type of message (data, audio, video, etc.), or a title of the message.

In one embodiment of the present invention, the user of the calling phone can make a selection of one of the choices on the menu interface received from the communication system. The selection can be accomplished by pressing a key on the keypad of the calling phone, selecting a menu choice by using a cursor or the like, by verbalizing one of the menu options, or by any other means that clearly selects one of the menu choices from the menu interface. The menu selection is then sent to the communication system by the calling phone.

The communication system receives (207) the selection of one of the stored messages from the calling phone. The communication system preferably receives the selection on the first connection established between the calling phone and the multimedia mail system.

The communication system initiates (209) a second connection between the multimedia mail system in response to the selection of one of the plurality of stored messages. The second connection can have a different Quality of Service (QoS) than the first connection. For example, the first connection has a QoS sufficient to support packet data. When the second connection is intended to carry streaming audio or streaming video, the second connection will have a higher QoS than the first connection.

The communication system sends (211) the selected stored message from the multimedia mailbox to the calling phone over the second connection. By utilizing a second connection different than the first connection, the QoS can be different for the different connection. This facilitates the use of a low QoS for the first connection, and a higher QoS connection for the second connection, which allows video, audio, and other messages to be retrieved by the user on the second connection.

The calling phone can determine that it desires a connection be established between the calling phone and the depositor of the message in the multimedia mailbox. The calling phone would then send a callback indicator to the multimedia mail system, preferably in the selection. The callback indicator indicates that the calling phone is requesting a connection be established between the calling phone and the depositor of the multimedia message.

If the multimedia mail system determines (213) that a callback indicator has been sent, the multimedia mail system establishes (215) a call between the calling phone and the depositor of the multimedia message. The multimedia mail system preferably makes this determination by checking the callback indicator. The call between the calling phone and the depositor may have a QoS indicator that exceeds a predetermined service level to ensure that the call has an adequate level of service to successfully complete the call. For example, the first connection may be a data connection and the second connection may be a voice call, text messaging, or a video call.

The present invention thereby provides an improvement over the current state of the art. The present invention provides a method and communication system that allows a user to retrieve messages from a mailbox in any order. Further, the present invention allows a multimedia mail user to be able to obtain information about all messages in the mailbox without having to listen to each message. Still further, the present invention provides a method and communication system to allow a multimedia mail system user to retrieve mail message and make a connection with a depositor of a mail message, without requiring the user to connect to the mail system using a high QoS connection.

While this invention has been described in terms of certain examples thereof, it is not intended that it be limited to the above description, but rather only to the extent set forth in the claims that follow.

We claim:

1. A method for retrieving multimedia messages from a multimedia mailbox, the method comprising:
receiving a request from a calling phone, the request being a request to retrieve a multimedia message from a multimedia mailbox associated with a user of the IP capable phone;
determining if the calling phone is capable of processing IP data; and
if the calling phone is capable of processing IP data, sending a text-based menu interface to the calling phone.

2. A method for retrieving multimedia messages from a multimedia mailbox in accordance with claim 1, wherein the request includes an indicator that the calling phone is capable of processing a text-based menu interface.

3. A method for retrieving multimedia messages from a multimedia mailbox in accordance with claim 2, wherein the step of determining if the calling phone is capable of processing IP data comprises checking the indicator.

4. A method for retrieving multimedia messages from a multimedia mailbox in accordance with claim 1, wherein the step of sending a text-based menu interface comprises sending an HTML (HyperText Markup Language) message.

5. A method for retrieving multimedia messages from a multimedia mailbox in accordance with claim 1, wherein the step of sending a text-based menu interface comprises sending a Wireless Application Protocol (WAP) message.

6. A method for retrieving multimedia messages from a multimedia mailbox in accordance with claim 1, wherein the calling phone is a wireline phone.

7. A method for retrieving multimedia messages from a multimedia mailbox in accordance with claim 1, wherein the calling phone is a softphone on a computer.

8. A method for retrieving multimedia messages from a multimedia mailbox in accordance with claim 1, wherein the calling phone is a wireless phone.

9. A method for retrieving multimedia messages from a multimedia mailbox in accordance with claim 1, wherein the calling phone is a Personal Digital Assistant (PDA).

10. A method for retrieving multimedia messages from a multimedia mailbox in accordance with claim 1, wherein the calling phone is a pen tablet.

11. A method for retrieving multimedia messages from a multimedia mailbox in accordance with claim 1, wherein the calling phone is a web pad.

12. A method for retrieving multimedia messages from a multimedia mailbox in accordance with claim 1, wherein the text-based menu interfaces lists a plurality of stored messages associated with the user, the method further comprising the step of receiving a selection of one of the plurality of stored messages.

13. A method for retrieving multimedia messages from a multimedia mailbox in accordance with claim 12, wherein the request utilizes a first connection, the method further comprising initiating a second connection between the multimedia mail system in response to the selection of one of the plurality of stored messages.

14. A method for retrieving multimedia messages from a multimedia mailbox in accordance with claim 13, wherein the step of initiating a second connection between the multimedia mail system comprises initiating a second connection between the multimedia mail system having a different Quality of Service (QoS) than the first connection.

15. A method for retrieving multimedia messages from a multimedia mailbox in accordance with claim 14, wherein the QoS is higher for the second connection than the first connection.

16. A method for retrieving multimedia messages from a multimedia mailbox in accordance with claim 14, wherein the QoS for the second connection is sufficient to support streaming audio.

17. A method for retrieving multimedia messages from a multimedia mailbox in accordance with claim 14, wherein the QoS for the second connection is sufficient to support streaming video.

18. A method for retrieving multimedia messages from a multimedia mailbox in accordance with claim 13, further comprising sending the selected one of the plurality of stored messages from the multimedia mailbox to the calling phone over the second connection.

19. A method for retrieving multimedia messages from a multimedia mailbox in accordance with claim 13, further comprising the step of receiving a callback indicator from the calling phone, the callback indicator indicating that the calling phone is requesting a connection be established between the calling phone and the depositor of the multimedia message.

20. A method for retrieving multimedia messages from a multimedia mailbox in accordance with claim 19, further comprising establishing a call between the calling phone and the depositor of the multimedia message.

21. A method for retrieving multimedia messages from a multimedia mailbox in accordance with claim 20, wherein the call has a Quality of Service (QoS) indicator, and wherein the QoS indicator exceeds a predetermined service level.

22. A method for retrieving multimedia messages from a multimedia mailbox in accordance with claim 20, wherein the call between the calling phone and the depositor of the multimedia message is a voice call.

23. A method for retrieving multimedia messages from a multimedia mailbox in accordance with claim 20, wherein the call between the calling phone and the depositor of the multimedia message comprises text messaging.

24. A method for retrieving multimedia messages from a multimedia mailbox in accordance with claim 20, wherein the call between the calling phone and the depositor of the multimedia message is a video call.
